(19) United States
(12) Patent Application Publication
(10) Pub. No.: US 2024/0379292 A1
(43) Pub. Date: Nov. 14, 2024

(54) MULTILAYER ELECTRONIC COMPONENT

(71) Applicant: SAMSUNG ELECTRO-MECHANICS CO., LTD., Suwon-si (KR)

(72) Inventors: Hyun Sik Chae, Suwon-si (KR); Ji Hyeon Lee, Suwon-si (KR); Eun Jung Lee, Suwon-si (KR); Jong Ho Lee, Suwon-si (KR); Yong Hwa Lee, Suwon-si (KR); Min Soo Kim, Suwon-si (KR); Dong Jun Jung, Suwon-si (KR); Hyo Sub Kim, Suwon-si (KR)

(73) Assignee: SAMSUNG ELECTRO-MECHANICS CO., LTD., Suwon-si (KR)

(21) Appl. No.: 18/606,625

(22) Filed: Mar. 15, 2024

(30) Foreign Application Priority Data
May 12, 2023 (KR) 10-2023-0061808
Aug. 22, 2023 (KR) 10-2023-0110119

(51) Int. Cl. H01G 4/224; H01G 4/232; H01G 4/248; H01G 4/30

(52) U.S. Cl. CPC H01G 4/224; H01G 4/232; H01G 4/248; H01G 4/30

(57) ABSTRACT

A multilayer electronic component includes a body including a capacitance forming portion including a dielectric layer and an internal electrode alternately disposed in a first direction, and cover portions disposed on both end surfaces of the capacitance forming portion in the first direction, respectively, and including a first surface and a second surface opposing each other in the first direction, a third surface and a fourth surface opposing each other in a second direction, and a fifth surface and a sixth surface opposing each other in a third direction; external electrodes disposed on the third and fourth surfaces of the body, respectively; and side margin portions disposed on the fifth and sixth surfaces of the body, respectively. At least one of the capacitance forming portion, the cover portion, or the side margin portions includes a secondary phase including gallium (Ga).

### CROSS-REFERENCE TO RELATED APPLICATION(S)

This application claims benefit of priority to Korean Patent Application No. 10-2023-0061808 filed on May 12, 2023 and Korean Patent Application No. 10-2023-0110119 filed on Aug. 22, 2023 in the Korean Intellectual Property Office, the disclosures of which are incorporated herein by reference in their entireties.

### TECHNICAL FIELD

The present disclosure relates to a multilayer electronic component.

A multilayer ceramic capacitor (MLCC), a multilayer electronic component, may be a chip condenser mounted on the printed circuit boards of various types of electronic products such as image display devices including a liquid crystal display (LCD), a plasma display panel (PDP), or the like, a computer, a smartphone, a mobile phone, or the like, serving to charge or discharge electricity therein or therefrom.

Such a multilayer ceramic capacitor may be used as a component of various electronic devices, as the multilayer ceramic capacitor has a small size with high capacitance and is easily mounted. As various electronic devices such as computers, mobile devices, or the like have been miniaturized and implemented with high-output, demand for miniaturization and high capacitance of the multilayer ceramic capacitors has increased.

In order to implement a multilayer ceramic capacitor with a small size and high capacitance, maximization of an effective area (an increase in an effective volume fraction necessary for realizing capacitance) of an electrode is required. In order to implement a multilayer ceramic capacitor having a small size with high capacitance, as described above, in manufacturing the multilayer ceramic capacitor, an internal electrode may be exposed in a width direction of a body to maximize an area in a width direction of the internal electrode by a margin-free design, but, after manufacturing the body and before a sintering operation, a method in which a ceramic green sheet for a side margin portion is separately attached to a surface of the electrode exposed in the width direction of the body, may be applied.

As the side margin portion is formed by the method in which a ceramic green sheet for a side margin portion is separately attached, capacitance per unit volume of the capacitor may be improved, but there may be risks that permeation of external moisture or permeation of a plating solution during a plating process through an interface joint portion between the body and the side margin portion causes various problems such as shortening of a lifespan of a chip, occurrence of defects, or the like, and development for overcoming the same is required.

More specifically, in a process of forming the side margin portion, many pores may be generated at an interface on which the body and the side margin portion are in contact to reduce reliability, concentration of an electrical field may be generated by the pores, to cause a problem of decreasing a breakdown voltage (BDV). In addition, as an interfacial joint portion occurs on a boundary between the body and the side margin portion, a decrease in bonding strength and accordingly a decrease in moisture resistance reliability may occur, or the pores may cause a decrease in moisture resistance reliability due to a decrease in sintering compaction.

### SUMMARY

An aspect of the present disclosure is to provide a multilayer electronic component having excellent compaction of a dielectric even when sintered at a low temperature.

An aspect of the present disclosure is to provide a multilayer electronic component having a small number of pores and improved moisture resistance reliability.

An aspect of the present disclosure is to provide a multilayer electronic component having improved electrical characteristics by reducing a size of a dielectric grain to alleviate an electrical field concentration phenomenon.

However, various problems to be solved by the present disclosure are not limited to the above-described contents, and can be more easily understood in a process of explaining specific embodiments of the present disclosure.

According to an aspect of the present disclosure, a multilayer electronic component includes a body including a capacitance forming portion including a dielectric layer and an internal electrode alternately disposed in a first direction, and cover portions disposed on both end surfaces of the capacitance forming portion in the first direction, respectively, and including a first surface and a second surface opposing each other in the first direction, a third surface and a fourth surface, connected to the first and second surfaces and opposing each other in a second direction, and a fifth surface and a sixth surface, connected to the first to fourth surfaces and opposing each other in a third direction; external electrodes disposed on the third and fourth surfaces of the body, respectively; and side margin portions disposed on the fifth and sixth surfaces of the body, respectively. At least one of the capacitance forming portion, the cover portions, or the side margin portions includes a secondary phase including gallium (Ga).

According to another aspect of the present disclosure, a multilayer electronic component includes a body including a capacitance forming portion including a dielectric layer and an internal electrode alternately disposed in a first direction, and including a first surface and a second surface opposing each other in the first direction, a third surface and a fourth surface, connected to the first and second surfaces and opposing each other in a second direction, and a fifth surface and a sixth surface, connected to the first to fourth surfaces and opposing each other in a third direction; external electrodes disposed on third and fourth surfaces of the body, respectively; and side margin portions disposed on fifth and sixth surfaces of the body, respectively. 0<MG and 0≤AG≤MG are satisfied, in which MG is the number of moles of gallium (Ga) relative to 100 moles of titanium (Ti) included in one of the side margin portions and AG is the number of moles of gallium (Ga) relative to 100 moles of titanium (Ti) included in the capacitance forming portion.

### BRIEF DESCRIPTION OF DRAWINGS

The above and other aspects, features, and advantages of the present disclosure will be more clearly understood from the following detailed description, taken in conjunction with the accompanying drawings.

FIG. 1 schematically illustrates a perspective view of a multilayer electronic component according to an embodiment of the present disclosure.

FIG. 2 schematically illustrates a perspective view of the multilayer electronic component of FIG. 1 excluding external electrodes.

FIG. 3 schematically illustrates a perspective view of the multilayer electronic component of FIG. 1 excluding external electrodes and side margin portions.

FIG. 4 schematically illustrates an exploded perspective view illustrating a stack structure of internal electrodes.

FIG. 5 schematically illustrates a cross-sectional view of FIG. 1, taken along line I-I′.

FIG. 6 schematically illustrates a cross-sectional view of FIG. 1, taken along line II-II′.

FIG. 7 schematically illustrates a dielectric microstructure.

FIG. 8A is an image of a side margin portion, captured in a HAADF mode using a transmission electron microscope (TEM), FIG. 8B is an image of silicon (Si) and gallium (Ga) in the same region, analyzed by EDS, and FIG. 8C is an image of gallium (Ga) in the same region, analyzed by EDS.

FIG. 9A is an image of a capacitance forming portion and a side margin portion in a Comparative Example, captured by an SEM, corresponding to portion M in FIG. 6, and FIG. 9B is an image of a capacitance forming portion and a side margin portion in an Inventive Example, captured by an SEM, corresponding to portion M in FIG. 6.

FIG. 10A is a moisture resistance reliability evaluation graph of a Comparative Example, and FIG. 10B is a moisture resistance reliability evaluation graph of an Inventive Example.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes, sizes, and the like, of the elements in the drawings may be exaggerated for clarity of description, and the elements denoted by the same reference numerals in the drawings may be the same elements.

In addition, in order to clearly illustrate the present disclosure in the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawing, a first direction may be defined as a stack direction or a thickness T direction, a second direction may be defined as a length L direction, and a third direction may be defined as a width W direction.

### Multilayer Electronic Component

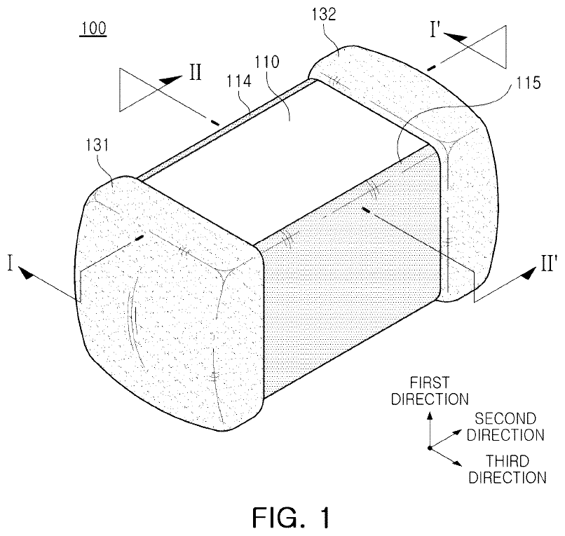

FIG. 1 schematically illustrates a perspective view of a multilayer electronic component according to an embodiment of the present disclosure.

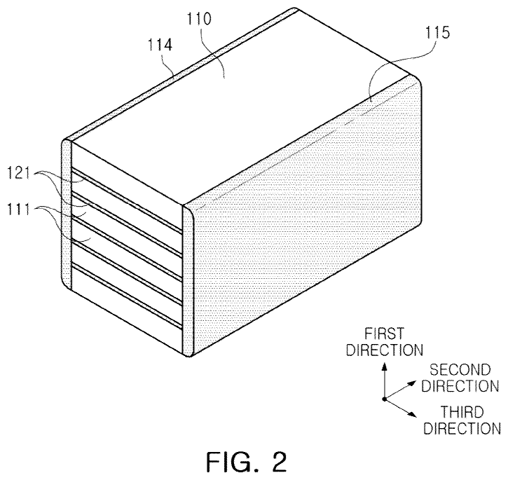

FIG. 2 schematically illustrates a perspective view of the multilayer electronic component of FIG. 1 excluding external electrodes.

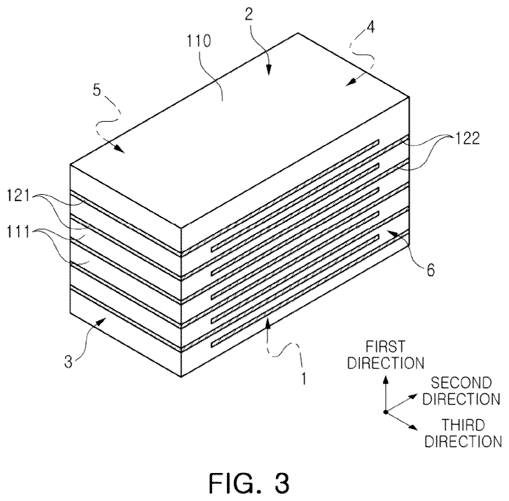

FIG. 3 schematically illustrates a perspective view of the multilayer electronic component of FIG. 1 excluding external electrodes and side margin portions.

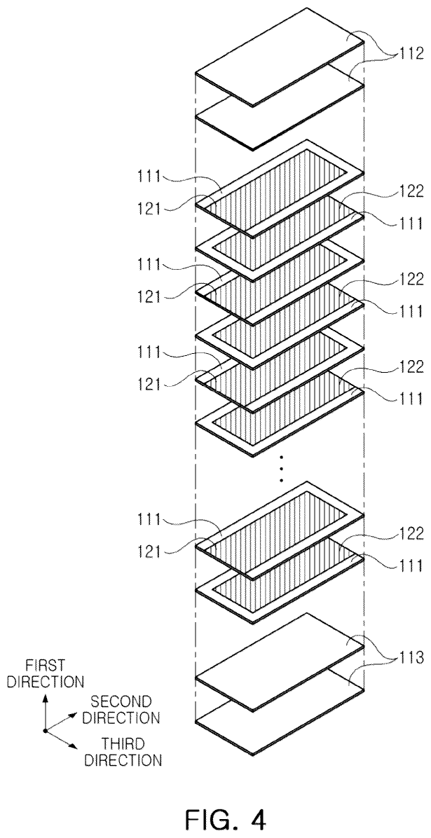

FIG. 4 schematically illustrates an exploded perspective view illustrating a stack structure of internal electrodes.

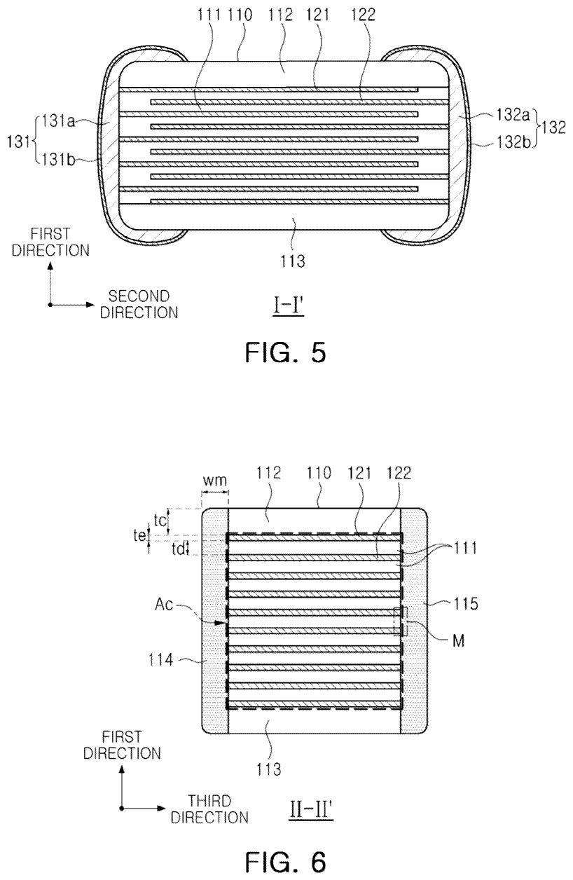

FIG. 5 schematically illustrates a cross-sectional view of FIG. 1, taken along line I-I′.

FIG. 6 schematically illustrates a cross-sectional view of FIG. 1, taken along line II-II′.

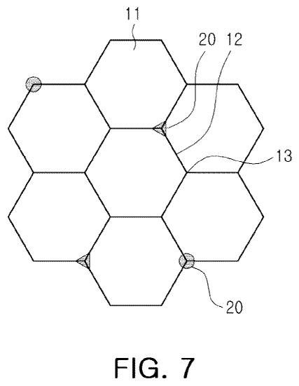

FIG. 7 schematically illustrates a dielectric microstructure.

Hereinafter, a multilayer electronic component according to an example embodiment of the present disclosure will be described in detail with reference to FIGS. 1 to 7. A multilayer ceramic capacitor will be described as an example of a multilayer electronic component, but the example embodiment may also be applied to various electronic products using a dielectric composition, such as an inductor, a piezoelectric element, a varistor, a thermistor, or the like.

A multilayer electronic component 100 according to an embodiment of the present disclosure may include a body 110 including a capacitance forming portion Ac including a dielectric layer 111 and an internal electrode (121 and 122) alternately disposed with the dielectric layer 111 in a first direction, and cover portions 112 and 113 disposed on both end surfaces of the capacitance forming portion Ac in the first direction, and including first and second surfaces 1 and 2 opposing each other, third and fourth surfaces 3 and 4 connected to the first and second surfaces 1 and 2 and opposing each other in a second direction, and fifth and sixth surfaces 5 and 6 connected to first to fourth surfaces 1, 2, 3, and 4 and opposing each other in a third direction; external electrodes 131 and 132 disposed on the third and fourth surfaces 3 and 4; and side margin portions 114 and 115 disposed on the fifth and sixth surfaces 5 and 6. At least one of the capacitance forming portion Ac, the cover portions 112 and 113, or the side margin portions 114 and 115 may include a secondary phase 20 including gallium (Ga).

A multilayer electronic component 100 according to another embodiment of the present disclosure may include a body 110 including a capacitance forming portion Ac including a dielectric layer 111 and an internal electrode (121 and 122) alternately disposed with the dielectric layer 111 in a first direction, and including first and second surfaces 1 and 2 opposing each other, third and fourth surfaces 3 and 4 connected to the first and second surfaces 1 and 2 and opposing each other in a second direction, and fifth and sixth surfaces 5 and 6 connected to first to fourth surfaces 1, 2, 3, and 4 and opposing each other in a third direction; external electrodes 131 and 132 disposed on the third and fourth surfaces 3 and 4; and side margin portions 114 and 115 disposed on the fifth and sixth surfaces 5 and 6. If the number of moles of gallium (Ga) relative to 100 moles of titanium (Ti) included in each of the side margin portions 114 and 115 is MG, and the number of moles of gallium (Ga) relative to 100 moles of titanium (Ti) included in the capacitance forming portion Ac is AG, 0<MG and 0≤ AG≤ MG may be satisfied.

The body 110 may have the dielectric layer 111 and the internal electrode (121 and 122) alternately stacked.

More specifically, the body 110 may include a first internal electrode 121 and a second internal electrode 122, disposed in the body 110 and alternately arranged to face each other with the dielectric layer 111 therebetween, to include the capacitance forming portion Ac that forms capacitance.

Although the specific shape of the body 110 is not particularly limited, the body 110 may have a hexahedral shape or the like, as illustrated. Due to shrinkage of ceramic powder particles included in the body 110 during a sintering process, the body 110 may not have a perfectly straight hexahedral shape, but may have a substantially hexahedral shape.

The body 110 may include first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

A plurality of dielectric layers 111 forming the body 110 may be in a sintered state, and a boundary between adjacent dielectric layers 111 may be integrated to such an extent that it may be difficult to identify the same without using a scanning electron microscope (SEM).

A raw material for forming the dielectric layer 111 is not particularly limited, as long as sufficient capacitance may be obtained therewith. For example, a barium titanate-based material, a lead composite perovskite-based material, a strontium titanate-based material, or the like may be used. The barium titanate-based material may include a BaTiO₃-based ceramic powder, and examples of the ceramic powder may include BaTiO₃, or (Ba₁₋ₓCaₓ) TiO₃(0<x<1), Ba(Ti_{1-y}Ca_{y})O₃(0<x<1), (Ba₁₋ₓCaₓ) (Ti_{1-y}Zr_{y})O₃(0<x<1, 0<x<1), Ba (Ti_{1-y}Zr_{y})O₃(0<x<1), or the like, in which calcium (Ca), zirconium (Zr), or the like is partially dissolved in BaTiO₃, or the like.

In addition, various ceramic additives, organic solvents, binders, dispersants, or the like may be added to the powder of barium titanate (BaTiO₃), and the like, as the raw material for forming the dielectric layer 111, according to the purpose of the present disclosure.

Additionally, the dielectric layer 111 may be formed using a dielectric material such as barium titanate (BaTiO₃), and may therefore include a dielectric microstructure after sintering. The dielectric microstructure may include a plurality of grains 11 and a grain boundary 12 disposed between adjacent grains 11, and may include a triple point 13, which may be a point at which three or more grain boundaries 12 meet, in plural.

A thickness td of the dielectric layer 111 does not need to be particularly limited.

To more easily achieve miniaturization and high capacitance of the multilayer electronic component, the thickness of the dielectric layer 111 may be 0.6 μm or less, more preferably 0.4 μm or less.

In this case, the thickness td of the dielectric layer 111 may mean the thickness td of the dielectric layer 111 disposed between the first and second internal electrodes 121 and 122.

The thickness td of the dielectric layer 111 may mean a size of the dielectric layer 111 in the first direction. Also, the thickness td of the dielectric layer 111 may mean an average thickness td of the dielectric layer 111, or may mean an average size of the dielectric layer 111 in the first direction.

The average size of the dielectric layer 111 in the first direction may be measured by scanning images of cross-sections of the body 110 in the first and second directions with a scanning electron microscope (SEM) at a magnification of 10,000. More specifically, the average size of one dielectric layer 111 in the first direction means an average value calculated by measuring a size of one dielectric layer 111 in the second direction at thirty (30) equally spaced points in the scanned image in the first direction. The thirty (30) equally spaced points may be designated in the capacitance forming portion Ac. In addition, when such an average value is determined by extensively using measurements of average values to ten (10) dielectric layers 111, the average size of the dielectric layers 111 in the first direction may be further generalized.

The internal electrode (121 and 122) may be alternately stacked with the dielectric layer 111.

The internal electrode (121 and 122) may include the first internal electrode 121 and the second internal electrode 122, and the first and second internal electrodes 121 and 122 may be alternately disposed to oppose each other with the dielectric layers 111, constituting the body 110, interposed therebetween, and may be exposed from the third and fourth surfaces 3 and 4 of the body 110, respectively.

More specifically, the first internal electrode 121 may be spaced apart from the fourth surface 4, and may be exposed from the third surface 3, and the second internal electrode 122 may be spaced apart from the third surface 3, and may be exposed from the fourth surface 4. The first external electrode 131 may be disposed on the third surface 3 of the body 110 to be connected to the first internal electrode 121, and the second external electrode 132 may be disposed on the fourth surface 4 of the body 110 to be connected to the second internal electrode 122.

For example, the first internal electrode 121 may not be connected to the second external electrode 132, but may be connected to the first external electrode 131, and the second internal electrode 122 may not be connected to the first external electrode 131, but may be connected to the second external electrode 132. In this case, the first and second internal electrodes 121 and 122 may be electrically separated from each other by the dielectric layer 111 interposed therebetween.

The body 110 may be formed by alternately stacking a ceramic green sheet on which the first internal electrode 121 is printed and a ceramic green sheet on which the second internal electrode 122 is printed, and then sintering the stacked ceramic green sheets.

A material for forming the internal electrode (121 and 122) not particularly limited, and a material having excellent electrical conductivity may be used. For example, the internal electrode (121 and 122) may include nickel (Ni), copper (Cu), palladium (Pd), silver (Ag), gold (Au), platinum (Pt), tin (Sn), tungsten (W), titanium (Ti), and alloys thereof.

In addition, the internal electrode (121 and 122) may be formed by printing a conductive paste for the internal electrodes containing one or more of nickel (Ni), copper (Cu), palladium (Pd), silver (Ag), gold (Au), platinum (Pt), tin (Sn), tungsten (W), titanium (Ti), and alloys thereof, on the ceramic green sheets. As a printing method of the conductive paste for the internal electrodes, a screen-printing method, a gravure printing method, or the like may be used, but the present disclosure is not limited thereto.

A thickness the of the internal electrode (121 and 122) does not need to be particularly limited.

To more easily achieve miniaturization and high capacitance of the multilayer electronic component, the thickness of the internal electrode (121 and 122) may be 0.6 μm or less, more preferably 0.4 μm or less.

In this case, the thickness the of the internal electrode (121 and 122) may mean a size of the internal electrode (121 and 122) in the first direction. In addition, the thickness the of the internal electrode (121 and 122) may mean an average thickness the of the internal electrode (121 and 122), or may mean an average size of the internal electrode (121 and 122) in the first direction.

The average size of the internal electrode (121 and 122) in the first direction may be measured by scanning images of cross-sections of the body 110 in the first and second directions with a scanning electron microscope (SEM) at a magnification of 10,000. More specifically, the average size of one internal electrode in the first direction may be an average value calculated by measuring a size of one internal electrode in the second direction at thirty (30) equally spaced points in the scanned image. The thirty (30) equally spaced points may be designated in the capacitance forming portion Ac. In addition, when such an average value is determined by extensively using measurements of average values to ten (10) internal electrodes (121 and 122), the average size of the internal electrode (121 and 122) in the first direction may be further generalized.

The body 110 may include the cover portions 112 and 113 disposed on both end-surfaces of the capacitance forming portion Ac in the first direction.

More specifically, the cover portions 112 and 113 may include an upper cover portion 112 disposed above the capacitance forming portion Ac in the first direction, and a lower cover portion 113 disposed below the capacitance forming portion Ac in the first direction.

The upper cover portion 112 and the lower cover portion 113 may be formed by stacking a single dielectric layer 111 or two or more dielectric layers 111 on upper and lower surfaces of the capacitance forming portion Ac in the first direction, respectively, and may basically play a role in preventing damage to the internal electrode (121 and 122) due to physical or chemical stress.

The upper cover portion 112 and the lower cover portion 113 may not include the internal electrode (121 and 122), and may include the same material as the dielectric layer 111. For example, the upper cover portion 112 and the lower cover portion 113 may include a ceramic material, and may include, for example, a barium titanate (BaTiO₃)-based ceramic material.

Additionally, the cover portions 112 and 113 may be formed using a dielectric material such as barium titanate (BaTiO₃), and therefore include a dielectric may microstructure after sintering. The dielectric microstructure may include a plurality of grains 11 and a grain boundary 12 disposed between adjacent grains 11, and may include a triple point 13, which may be a point at which three or more grain boundaries 12 meet.

A thickness tc of each of the cover portions 112 and 113 does not need to be particularly limited.

To more easily achieve miniaturization and high capacitance of the multilayer electronic component, the thickness tc of each of the cover portions 112 and 113 may be 100 μm or less, preferably 30 μm or less, and, in case of ultra-small products, more preferably 20 μm or less.

In this case, the thickness tc of each of the cover portions 112 and 113 may mean a size of each of the cover portions 112 and 113 in the first direction. In addition, the thickness tc of each of the cover portions 112 and 113 may mean an average thickness tc of each of the cover portions 112 and 113, or may mean an average size of each of the cover portion 112 and 113 in the first direction.

The average size of each of the cover portions 112 and 113 in the first direction may be measured by scanning images of cross-sections of the body 110 in the first and second directions with a scanning electron microscope (SEM) at a magnification of 10,000. More specifically, the average size in the first direction may be an average value calculated by measuring the size in the first direction at thirty (30) equally spaced points in the second direction in the scanned image of one cover portion.

In addition, the average size of each of the cover portions 112 and 113 in the first direction measured by the above-described method may be substantially the same as the average size of each of the cover portions 112 and 113 in the first direction, in cross-sections of the body 110 in the first and third directions.

The side margin portions 114 and 115 may be disposed on both end-surfaces of the body 110 in the third direction.

More specifically, the side margin portions 114 and 115 may include a first side margin portion 114 disposed on the fifth surface 5 of the body 110, and a second side margin portion 115 disposed on the sixth surface 6 of the body 110. For example, the side margin portions 114 and 115 may be disposed on both end-surfaces of the body 110 in the third direction.

As illustrated, the side margin portions 114 and 115 may refer to regions between both ends of the body 110 in the first and third directions and a boundary surface of the body 110, in a cross-section of the body 110 cut in the first and third directions.

The side margin portions 114 and 115 may basically play a role in preventing damage to the internal electrode (121 and 122) due to physical or chemical stress.

The side margin portions 114 and 115 may be prepared by applying a conductive paste on a ceramic green sheet to form the internal electrode (121 and 122), except for a portion in which the side margin portions 114 and 115 are formed, and, to suppress a step difference due to the internal electrode (121 and 122), cutting the internal electrode (121 and 122) to expose the fifth and sixth surfaces 5 and 6 of the body 110, and then stacking a single dielectric layer 111 or two or more dielectric layers 111 in the third direction on both end-surfaces of the capacitance forming portion Ac in the third direction.

The first side margin portion 114 and the second side margin portion 115 may not include the internal electrode (121 and 122), and may include the same material as the dielectric layer 111. For example, the first side margin portion 114 and the second side margin portion 115 may include a ceramic material, and may include, for example, a barium titanate (BaTiO₃)-based ceramic material.

Additionally, the side margin portions 114 and 115 may be formed using a dielectric material such as barium titanate (BaTiO₃), and may therefore include a dielectric microstructure after sintering. The dielectric microstructure may include a plurality of grains 11 and a grain boundary 12 disposed between adjacent grains 11, and may include a triple point 13, which may be a point at which three or more grain boundaries 12 meet.

A width wm of each of the first and second side margin portions 114 and 115 does not need to be particularly limited.

To more easily achieve miniaturization and high capacitance of the multilayer electronic component 100, the width wm of each of the first and second side margin portions 114 and 115 may be 100 μm or less, and preferably 30 μm or less, and, in case of ultra-small products, more preferably 20 μm or less.

In this case, the width wm of each of the side margin portions 114 and 115 may mean a size of each of the side margin portions 114 and 115 in the third direction. Also, the width wm of each of the side margin portions 114 and 115 may mean an average width wm of each of the side margin portions 114 and 115, or may mean an average size of each of the side margin portions 114 and 115 in the third direction.

The average size of each of the side margin portions 114 and 115 in the third direction may be measured by scanning images of cross-sections of the body 110 in the first and third directions with a scanning electron microscope (SEM) at a magnification of 10,000. More specifically, the average size in the third direction may refer to an average value calculated by measuring sizes in the third direction at ten (10) equally spaced points in the first direction in a scanned image of one side margin portion.

To make a multilayer ceramic capacitor to have a small size with high capacitance, maximization of an effective area (an increase in an effective volume fraction necessary for realizing capacitance) of an electrode is required. To implement a multilayer ceramic capacitor having a small size with high capacitance, as described above, in manufacturing the multilayer ceramic capacitor, an internal electrode may be exposed in a width direction of a body to maximize an area in a width direction of the internal electrode by a margin-free design, but, after manufacturing the body and before a sintering operation, a method in which a ceramic green sheet for a side margin portion is separately attached to a surface of the electrode exposed in the width direction of the body, may be applied.

As the side margin portion is formed by the method in which a ceramic green sheet for a side margin portion is separately attached, capacitance per unit volume of the capacitor may be improved, but there may be risks that permeation of external moisture or permeation of a plating solution during a plating process through an interface joint portion between the body and the side margin portion causes various problems such as shortening of a lifespan of a chip, occurrence of defects, or the like, and development for overcoming the same is required.

More specifically, in a process of forming the side margin portion, many pores may be generated on an interface on which the body and the side margin portion are in contact to reduce reliability, concentration of an electrical field may be generated by the pores, to occur a problem of decreasing a breakdown voltage (BDV). In addition, as an interfacial joint portion occurs on a boundary between the body and the side margin portion, a decrease in bonding strength and accordingly a decrease in moisture resistance reliability may occur, or the pores may cause a decrease in moisture resistance reliability due to a decrease in sintering compaction.

To improve reliability of a multilayer electronic component, development for improving compaction of a side margin portion is underway. Currently, barium titanate (BaTiO₃) containing tin (Sn), as a ceramic material used in the side margin portion, may have an effect of reducing concentration of an electrical field to improve electrical characteristics, as an effect of reducing a grain size, but there may be a problem of increasing the number of pores to reduce reliability. To solve this problem, researches for improving reliability of the multilayer electronic component by suppressing formation of the pores using a low-temperature sintering material, known to lower a sintering temperature of a dielectric ceramic, have been conducted.

Since the low-temperature sintering material may have a low melting point but also a low boiling point, to be highly volatile, gasification may occur during a high-temperature sintering process of electronic components such as an MLCC mainly made of ceramics, which has a side effect of contaminating a sintering furnace, and it may be difficult to optimize process conditions, to have a risk of further promoting occurrence of the pores.

Therefore, since a multilayer electronic component according to an embodiment of the present disclosure may include gallium (Ga) in a dielectric microstructure of a dielectric material, a composition, a grain, or the like, used in the multilayer electronic component, the above-described side effects may not be generated even in a low-temperature sintering process. In addition, addition of gallium (Ga) may suppress occurrence of pores, may improve moisture resistance reliability, and may improve electrical characteristics, mechanical characteristics, or the like.

A description of the present disclosure may be applied to any microstructure in a multilayer electronic component, and may use a dielectric microstructure as an example, but is not particularly limited thereto. Specifically, the description of the present disclosure may be applied to a capacitance forming portion Ac including a dielectric layer 111, an internal electrode (121 and 122), and a margin portion (no reference numeral) of an end region of the internal electrode, not connected to an external electrode, in the second direction (longitudinal direction), and a cover portion (112 and 113), in a body 110, or side margin portions 114 and 115, for example.

The capacitance forming portion Ac described in the present disclosure may not strictly mean only a region forming capacitance, but may include a margin portion (no reference numeral) of an end region of the internal electrode, not connected to the external electrode, in the longitudinal direction.

In a multilayer electronic component 100 according to an embodiment of the present disclosure, at least one of the capacitance forming portion Ac, the cover portion (112 and 113), or the side margin portions 114 and 115 may include a secondary phase 20 containing gallium (Ga).

Since at least one of the capacitance forming portion Ac, the cover portions 112 and 113, or the side margin portions 114 and 115 may include the secondary phase 20 containing gallium (Ga), occurrence of pores in a dielectric microstructure included in the at least one of the capacitance forming portion Ac, the cover portions 112 and 113, or the side margin portions 114 and 115 may be suppressed to improve moisture resistance reliability or improve electrical and mechanical characteristics.

In addition, as described above, at least one of the dielectric layer 111, the capacitance forming portion Ac, the cover portions 112 and 113, or the side margin portions 114 and 115 may include a plurality of grains 11 and a grain boundary 12 disposed between adjacent grains 11, and at least one of the grains 11 may include gallium (Ga), and at least one grain boundary 12 may include gallium (Ga).

In the present disclosure, the “secondary phase” may mean a particle, a grain, or segregation having a different composition from a perovskite-based (ABO₃) dielectric grain. Specifically, an atomic percentage (at %) of barium (Ba) in secondary phase particles may be 30.0 at % or less, an atomic percentage (at %) of titanium (Ti) in the secondary phase particles may be 30.0 at % or less, an atomic percentage (at %) of silicon (Si) in the secondary phase particles may be 15.0 at % or less, an atomic percentage (at %) of aluminum (Al) in the secondary phase particles may be 15.0 at % or less, or an atomic percentage (at %) of gallium (Ga) in the secondary phase particles may be 0.2 at % or more. Additionally, the secondary phase particles may refer to particles that satisfy all of the atomic percentage (at %) conditions of barium (Ba), titanium (Ti), silicon (Si), aluminum (Al), and gallium (Ga).

More specifically, an atomic percentage (at %) of gallium (Ga) included in the secondary phase 20 may be 0.2 at& or more.

When the atomic percentage (at %) of gallium (Ga) included in the secondary phase 20 satisfies 0.2 at % or more, occurrence of the pores in the dielectric microstructure may be suppressed, and moisture resistance reliability may be improved.

An upper limit value of the atomic percentage (at %) of gallium (Ga) included in the secondary phase 20 is not particularly limited to improve moisture resistance reliability, but to prevent side effects due to excessive addition of gallium (Ga), may be 1.0 at % or less, and more preferably 0.7 at % or less.

When the atomic percentage (at %) of gallium (Ga) included in the secondary phase 20 is less than 0.2 at %, distinction from noise may not be clear during EDS analysis, or an effect of suppressing occurrence of the pores may be insufficient. Therefore, an effect of improving moisture resistance reliability may not be excellent.

In the present disclosure, as an example of a more specific method of measuring amounts of elements included in each component of the multilayer electronic component 100, in a destruction method, components in a dielectric grain may be analyzed in a central portion of a chip using SEM-EDS, TEM-EDS or STEM-EDS. First, a thinly sliced analysis sample may be prepared using a focused ion beam (FIB) device in a region including a dielectric microstructure among the cross-sections of a sintered body. Then, a damaged layer on a surface of the thinned sample may be removed using argon (Ar) ion milling, and then each component may be mapped in an image obtained using SEM-EDS, TEM-EDS, or STEM-EDS to proceed with qualitative/quantitative analysis. In this case, a graph for the qualitative/quantitative analysis of each component may be expressed in terms of mass percentage (wt %), atomic percentage (at %), or mole percentage (mol %) of each element.

In another method, the chip may be pulverized to select a region containing a dielectric microstructure, and a portion containing the selected dielectric microstructure may be analyzed using a device such as an inductively coupled plasma spectroscopy (ICP-OES), an inductively coupled plasma mass spectrometry (ICP-MS), or the like, for the region containing the dielectric microstructure.

The secondary phase 20 may include glass, for example, silicon (Si)-based glass, or may include aluminum (Al)-silicon (Si)-based glass.

Since the secondary phase 20 may include glass, the formation of the secondary phase 20 due to the glass may be easier, elements other than gallium (Ga) may not be dissolved in a barium titanate (BaTiO₃)-based dielectric material, and may be included in the secondary phase 20.

More specifically, the secondary phase 20 may further include elements other than gallium (Ga).

For example, in addition to gallium (Ga), as a low-temperature sintering aid, at least one of lithium (Li), sodium (Na), potassium (K), rubidium (Rb), or cesium (Cs) may be further included. However, the low-temperature sintering aid, other than gallium (Ga), may be highly volatile, and there may be thus problems such as no ease to detect in a final product, contamination of a sintering furnace during the manufacturing process, or the like. Since the above-mentioned problems may be minimized by controlling sintering atmosphere or temperature conditions, and detection is possible with X-ray diffraction (XRD) analysis equipment or the like, at least one of lithium (Li), sodium (Na), potassium (K), rubidium (Rb), or cesium (Cs) may be further added as needed.

Additionally, when the secondary phase 20 is a secondary phase caused by glass, silicon (Si) may be further included, or aluminum (Al) may be further included.

When the secondary phase 20 includes silicon (Si), an atomic percentage (at %) of silicon (Si) included in the secondary phase 20 may be 15.0 at % or less, and preferably 13.4 at % or less.

And, when the secondary phase 20 includes aluminum (Al), an atomic percentage (at %) of aluminum (Al) included in the secondary phase 20 may be 15.0 at % or less, and preferably 11.2 at % or less.

In addition, although not particularly limited thereto, other sub-ingredient including at least one of tin (Sn), magnesium (Mg), vanadium (V), manganese (Mn), zirconium (Zr), titanium (Ti), barium (Ba), or a rare earth element may be further included.

In this case, the rare earth element may be at least one of lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), or ruthenium (Lu).

More specifically, a ratio of an atomic percentage (at %) of gallium (Ga) relative to an atomic percentage (at %) of silicon (Si) included in the secondary phase 20 may be 3.94% or more.

When the ratio of the atomic percentage (at %) of gallium (Ga) relative to the atomic percentage (at %) of silicon (Si) included in the secondary phase 20 satisfies 3.94% or more, occurrence of the pores in the dielectric microstructure may be suppressed, and moisture resistance reliability may be improved.

An upper limit value of the ratio of the atomic percentage (at %) of gallium (Ga) relative to the atomic percentage (at %) of silicon (Si) included in the secondary phase 20 is not particularly limited, but may be 8.00% or less, and preferably 7.21% or less.

When the ratio of the atomic percentage (at %) of gallium (Ga) relative to the atomic percentage (at %) of silicon (Si) included in the secondary phase 20 is less than 3.94%, an effect of suppressing occurrence of the pore may be minimal, and an effect of improving moisture resistance reliability may not be excellent.

Additionally, as described above, the secondary phase 20 may include tin (Sn).

In this case, the atomic percentage (at %) of tin (Sn) included in the secondary phase 20 may be 0.3 at % or less.

When the atomic percentage (at %) of tin (Sn) included in the secondary phase 20 satisfies 0.3 at % or less, it may be easy to control sizes of the grains 11, and concentration of an electrical field may be reduced due to a reduction in size of the grains 11 to improve electrical characteristics or the like, or mechanical characteristics may be improved.

When the atomic percentage (at %) of tin (Sn) included in the secondary phase 20 is more than 0.3 at %, there may be risks that excessive pores are generated and moisture resistance reliability is reduced.

In an embodiment of the present disclosure, the secondary phase 20 may be disposed at least one triple point 13.

The secondary phase 20 may not be only disposed at least one triple point 13, but may be disposed at least one grain boundary 12 or at least one grain 11.

In an embodiment of the present disclosure, the side margin portions 114 and 115 may include gallium (Ga).

This does not only mean a case in which gallium (Ga) is included in the secondary phase 20 included in the side margin portions 114 and 115, but also a dielectric microstructure of the side margin portions 114 and 115, for example, at least one grain 11, at least one grain boundary 12, or at least one triple point 13 may include gallium (Ga).

More specifically, the number of moles of gallium (Ga) relative to 100 moles of titanium (Ti) included in each of the side margin portions 114 and 115 may be 0.1 moles or more.

When the number of moles of gallium (Ga) relative to 100 moles of titanium (Ti) included in each of the side margin portions 114 and 115 satisfies 0.1 moles or more, occurrence of the pores in the dielectric microstructure included in the side margin portions 114 and 115 may be suppressed, and moisture resistance reliability may be improved.

An upper limit value of the number of moles of gallium (Ga) relative to 100 moles of titanium (Ti) included in each of the side margin portions 114 and 115 is not particularly limited as long as it is for improving moisture resistance reliability, but to prevent side effects such as a decrease in dielectric breakdown voltage (BDV) or the like due to excessive addition of gallium (Ga), the upper limit value of the number of moles of gallium (Ga) may be 3.0 moles or less, and preferably 2.0 moles or less.

When the number of moles of gallium (Ga) relative to 100 moles of titanium (Ti) included in each of the side margin portions 114 and 115 is less than 0.1 mole, an effect of suppressing occurrence of the pore may be minimal, and an effect of improving moisture resistance reliability may not be excellent.

The side margin portions 114 and 115 may further include elements other than gallium (Ga).

For example, in addition to gallium (Ga), as a low-temperature sintering aid, at least one of lithium (Li), sodium (Na), potassium (K), rubidium (Rb), or cesium (Cs) may be further included. The low-temperature sintering aid, other than gallium (Ga), may be highly volatile, and there may be thus problems such as no ease to detect in a final product, contamination of a sintering furnace during the manufacturing process, or the like. Since the above-mentioned problems may be minimized by controlling a sintering atmosphere or temperature conditions, and detection is possible with X-ray diffraction (XRD) analysis equipment or the like, at least one of lithium (Li), sodium (Na), potassium (K), rubidium (Rb), or cesium (Cs) may be further added as needed.

Additionally, the side margin portions 114 and 115 may further include silicon (Si), or may further include aluminum (Al). In addition, although not particularly limited thereto, other sub-ingredients including at least one of tin (Sn), magnesium (Mg), vanadium (V), manganese (Mn), zirconium (Zr), titanium (Ti), barium (Ba), or a rare earth element may be further included.

In this case, the rare earth element may be at least one of lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), or ruthenium (Lu), and preferably one of yttrium (Y), europium (Eu), gadolinium (Gd), terbium (Tb), dysprosium (Dy), holmium (Ho), or ytterbium (Yb).

As described above, the side margin portions 114 and 115 may include tin (Sn).

In this case, the number of moles of tin (Sn) relative to 100 moles of titanium (Ti) included in each of the side margin portions 114 and 115 may be 0.1 moles or more and 5.0 moles or less.

When the number of moles of tin (Sn) relative to 100 moles of titanium (Ti) included in each of the side margin portions 114 and 115 satisfies 0.1 moles or more and 5.0 moles or less, it may be easy to control sizes of the grains 11, and the sizes of the grains 11 may decrease and size distribution may be narrowed to improve moisture resistance reliability, electrical characteristics such as dielectric breakdown voltage (BDV) or the like may be improved, or mechanical characteristics or the like such as impact resistance, crack resistance, or the like may be improved.

When the number of moles of tin (Sn) relative to 100 moles of titanium (Ti) included in each of the side margin portions 114 and 115 less than 0.1 moles, an effect of improving moisture resistance reliability, electrical characteristics, or mechanical characteristics may be minimal, and when the number of moles of tin (Sn) exceeds 5.0 moles, sintering of the dielectric powder particles may not proceed due to excessive sintering inhibition, making it difficult to implement a dielectric microstructure, or there may be a risk that moisture resistance reliability or mechanical characteristics are deteriorated due to a small size of the dielectric grain.

In a multilayer electronic component 100 according to an embodiment of the present disclosure, if the number of moles of gallium (Ga) relative to 100 moles of titanium (Ti) included in each of the side margin portions 114 and 115 is MG, and the number of moles of gallium (Ga) relative to 100 moles of titanium (Ti) included in the capacitance forming portion Ac is AG, 0<MG and 0≤ AG≤ MG may be satisfied.

In this case, the capacitance forming portion Ac may be a concept including a dielectric layer 111, an internal electrode (121 and 122), and a margin portion (no reference numeral) of an end region of the internal electrode, not connected to an external electrode, in the second direction (longitudinal direction).

When gallium (Ga) is added to the side margin portions 114 and 115 (0<MG), occurrence of the pores may be suppressed and moisture resistance reliability may be improved.

Although gallium (Ga) is not added to the capacitance forming portion Ac (AG=0), when gallium (Ga) is added to the side margin portions 114 and 115, permeation of external moisture, permeation of a plating solution, or the like may be effectively prevented.

In addition, it may be obvious that when gallium (Ga) is added to the capacitance forming portion Ac (0<AG), permeation of external moisture, permeation of a plating solution, or the like may be prevented more effectively. When the number of moles of gallium (Ga) relative to 100 moles of titanium (Ti) included in the capacitance forming portion Ac does not exceed the number of moles of gallium (Ga) relative to 100 moles of titanium (Ti) included in each of the side margin portions 114 and 115 (AG≤ MG), unexpected defects in electrical or mechanical characteristics of the capacitance forming portion Ac may be prevented, and thus permeation of external moisture, permeation of a plating solution, or the like may be effectively prevented.

The side margin portions 114 and 115 may be separately attached to the fifth and sixth surfaces 5 and 6 of the body 110, such that a boundary surface between the body 110 and each of the side margin portions 114 and 115 become more vulnerable to permeation of external moisture or permeation of a plating solution. When gallium (Ga) is added to the side margin portions 114 and 115 (0<MG), moisture resistance reliability may be further improved, and as gallium (Ga) included in the side margin portions 114 and 115 diffuses into the capacitance forming portion Ac during a sintering process, moisture resistance reliability on a boundary surface between the body 110 and each of the side margin portions 114 and 115 may be further improved. In this case, the boundary surface between the body 110 and each of the side margin portions 114 and 115 may include a boundary surface between the capacitance forming portion Ac and each of the side margin portions 114 and 115.

Although the number of moles of gallium (Ga) relative to 100 moles of titanium (Ti) included in the capacitance forming portion Ac is greater than the number of moles of gallium (Ga) relative to 100 moles of titanium (Ti) included in each of the side margin portions 114 and 115 (MG<AG), when gallium (Ga) included in the body 110 diffuses into the side margin portions 114 and 115 during a sintering process, moisture resistance reliability on the boundary surface between the body 110 and each of the side margin portions 114 and 115 may be further improved, but when an amount of gallium (Ga) in each of the side margin portions 114 and 115 is small, it may be difficult to effectively prevent permeation of external moisture, permeation of a plating solution, or the like.

For example, when 0<MG and 0≤ AG≤ MG are satisfied, occurrence of pores in the microstructure may be further suppressed, and moisture resistance reliability may be improved.

In a multilayer electronic component 100 according to an embodiment of the present disclosure, if the number of moles of gallium (Ga) relative to 100 moles of titanium (Ti) included in the dielectric layer 111 is DG, 0<MG and 0≤DG≤MG may be satisfied.

Although gallium (Ga) is not added to the dielectric layer 111 relative to 100 moles of titanium (Ti) (DG=0), when gallium (Ga) is added to the side margin portions 114 and 115, permeation of external moisture, permeation of a plating solution, or the like may be effectively prevented.

In addition, it may be obvious that when a small amount of gallium (Ga) is added to the dielectric layer 111 (0<DG), permeation of external moisture, permeation of a plating solution, or the like may be more effectively prevented. When the number of moles of gallium (Ga) relative to 100 moles of titanium (Ti) included in the dielectric layer 111 is greater than the number of moles of gallium (Ga) relative to 100 moles of titanium (Ti) included in each of the side margin portions 114 and 115 (DG≤ MG), unexpected defects in electrical or mechanical characteristics of the dielectric layer 111 may be prevented, and permeation of external moisture, permeation of a plating solution, or the like may be effectively prevented.

The side margin portions 114 and 115 may be separately attached to the fifth and sixth surfaces 5 and 6 of the body 110 including the dielectric layer 111, respectively, such that a boundary surface between the body 110 and each of the side margin portions 114 and 115 become more vulnerable to permeation of external moisture or permeation of a plating solution. When gallium (Ga) is added to the side margin portions 114 and 115 (0<MG), moisture resistance reliability may be further improved, and as gallium (Ga) included in the side margin portions 114 and 115 diffuses into the dielectric layer 111 during a sintering process, moisture resistance reliability on a boundary surface between the dielectric layer 111 and each of the side margin portions 114 and 115 may be further improved. In this case, the boundary surface between the body 110 and each of the side margin portions 114 and 115 may include a boundary surface between the dielectric layer 111 and each of the side margin portions 114 and 115.

Although the number of moles of gallium (Ga) relative to 100 moles of titanium (Ti) included in the dielectric layer 111 is greater than the number of moles of gallium (Ga) relative to 100 moles of titanium (Ti) included in each of the side margin portions 114 and 115 (MG<DG), when gallium (Ga) included in the dielectric layer 111 diffuses into the side margin portions 114 and 115 during a sintering process, moisture resistance reliability on the boundary surface between the body 110 and each of the side margin portions 114 and 115 may be further improved, but when an amount of gallium (Ga) in each of the side margin portions 114 and 115 is small, it may be difficult to effectively prevent permeation of external moisture, permeation of a plating solution, or the like.

For example, when 0<MG and 0≤ DG≤ MG are satisfied, occurrence of pores in the microstructure may be further suppressed, and moisture resistance reliability may be improved.

In a multilayer electronic component 100 according to an embodiment of the present disclosure, if the number of moles of gallium (Ga) relative to 100 moles of titanium (Ti) included in each of the cover portions 112 and 113 is CG, 0<MG and 0≤CG≤MG may be satisfied.

Although gallium (Ga) is not added to each of the cover portions 112 and 113 (CG=0), when gallium (Ga) is added to the side margin portions 114 and 115 (0<MG), permeation of external moisture, permeation of a plating solution, or the like may be effectively prevented.

In addition, it may be obvious that when a small amount of gallium (Ga) is added to each of the cover portions 112 and 113 (0<CG), permeation of external moisture, permeation of a plating solution, or the like may be more effectively prevented.

When the number of moles of gallium (Ga) relative to 100 moles of titanium (Ti) included in each of the cover portions 112 and 113 does not exceed the number of moles of gallium (Ga) relative to 100 moles of titanium (Ti) included in each of the side margin portions 114 and 115 (CG≤MG), unexpected defects in electrical or mechanical characteristics of the each of the cover portions 112 and 113 may be prevented, and permeation of external moisture, permeation of a plating solution, or the like may be effectively prevented.

The side margin portions 114 and 115 may be separately attached to the fifth and sixth surfaces 5 and 6 of the body 110 including the cover portions 112 and 113, respectively, such that a boundary surface between the cover portions 112 and 113 and each of the side margin portions 114 and 115 become more vulnerable to permeation of external moisture or permeation of a plating solution. When gallium (Ga) is added to the side margin portions 114 and 115 (0<MG), moisture resistance reliability may be further improved, and as gallium (Ga) included in the side margin portions 114 and 115 diffuses into the cover portions 112 and 113 during a sintering process, moisture resistance reliability on a boundary surface between the cover portions 112 and 113 and each of the side margin portions 114 and 115 may be further improved.

Although the number of moles of gallium (Ga) relative to 100 moles of titanium (Ti) included in each of the cover portions 112 and 113 is greater than the number of moles of gallium (Ga) relative to 100 moles of titanium (Ti) included in each of the side margin portions 114 and 115 (MG<CG), when gallium (Ga) included in the cover portions 112 and 113 diffuses into the side margin portions 114 and 115 during a sintering process, moisture resistance reliability on the boundary surface between the cover portions 112 and 113 and each of the side margin portions 114 and 115 may be further improved, but when an amount of gallium (Ga) in each of the side margin portions 114 and 115 is small, it may be difficult to effectively prevent permeation of external moisture, permeation of a plating solution, or the like. This may be because ends of the internal electrode (121 and 122) in the third direction are in contact with or located close to the side margin portions 114 and 115, and as a result, it is easy for permeation of external moisture, permeation of a plating solution, or the like in the side margin portions 114 and 115, as compared to the cover portions 112 and 113.

For example, when 0<MG and 0≤CG≤MG are satisfied, occurrence of pores in the microstructure may be further suppressed, and moisture resistance reliability may be improved.

In a multilayer electronic component 100 according to an embodiment of the present disclosure, based on cross-sections of the side margin portions 114 and 115 in the first and second directions (thickness and length directions), the side margin portions 114 and 115 are in contact with the external electrodes 131 and 132, respectively, and a region falling within 10 μm in a direction facing the side margin portions 114 and 115 from an interface on which the side margin portions 114 and 115 and the external electrodes 131 and 132 are in contact may include gallium (Ga).

The interface between the side margin portions 114 and 115 and the external electrodes 131 and 132 may correspond to a path through which external moisture or a plating solution passes, which may cause a problem in which moisture resistance reliability is reduced. When a region falling within 10 μm in a direction facing the side margin portions 114 and 115 from an interface on which the side margin portions 114 and 115 and the external electrodes 131 and 132 are in contact includes gallium (Ga), occurrence of pores may be more suppressed to more effectively improve moisture resistance reliability of a region serving as a path for permeation of external moisture of permeation of a plating solution.

In this case, the statement indicating that a region falling within 10 μm in a direction facing the side margin portions 114 and 115 from an interface on which the side margin portions 114 and 115 and the external electrodes 131 and 132 are in contact includes gallium (Ga) may mean that the microstructure includes gallium (Ga), and may mean that the grains 11, the grain boundary 12, the triple point 13, the secondary phase 20, or the like, disposed in the region, includes gallium (Ga), to suppress occurrence of pores and improve moisture resistance reliability.

In the present disclosure, the statement indicating that the side margin portions 114 and 115 include gallium (Ga) is not particularly limited thereto, but may mean that the number of pores per unit area of 150 μm² of each of side margin portions 114 and 115 is 30 or less, preferably 25 or less, and more preferably 21 or less.

When the number of pores per unit area of 150 μm² satisfies 30 or less, moisture resistance reliability may be improved.

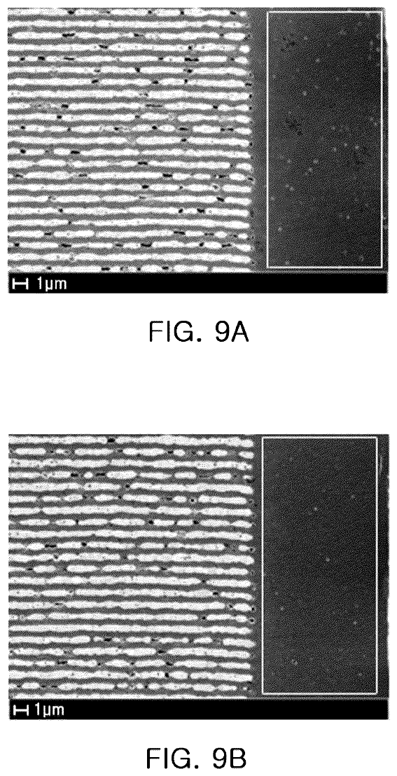

Referring to FIG. 9B, which may be an embodiment of the present disclosure, as an example of a unit area of 150 μm², the unit area of 150 μm² may mean 150 μm² of a side margin portion, when an image of a region including an end of an internal electrode and one side margin portion is captured by a scanning electron microscope (SEM), based on a cross-section in the first and third directions at a second direction center of the multilayer electronic component 100. In this case, the region of 150 μm² is not particularly limited thereto, but may correspond to a region in which a size in the third direction×a size in the first direction is 7.5 μm×20 μm.

In an embodiment of the present disclosure, a structure in which the multilayer electronic component 100 has two external electrodes 131 and 132 is illustrated, but the number, shapes, or the like of the external electrodes 131 and 132 may be changed, depending on a shape of the internal electrode (121 and 122), or other purposes.

The external electrode (131 and 132) may be disposed on the body 110 and connected to the internal electrode (121 and 122).

More specifically, the external electrode (131 and 132) may include first and second external electrodes 131 and 132 disposed on the third and fourth surfaces 3 and 4 of the body 110, respectively, and may be connected to the first and second internal electrodes 121 and 122, respectively. For example, the first external electrode 131 may be disposed on the third surface 3 of the body, and may be connected to the first internal electrode 121, and the second external electrode 132 may be disposed on the fourth surface 4 of the body, and may be connected to the second internal electrode 122.

Additionally, the external electrodes 131 and 132 may be disposed to extend on portions of the first and second surfaces 1 and 2 of the body 110, or may be disposed to extend on portions of the fifth and sixth surfaces 5 and 6 of the body 110. For example, the first external electrode 131 may be disposed on portions of the first, second, fifth, and sixth surfaces 1, 2, 5, and 6 of the body 110, and on the third surface 3 of the body 110, and the second external electrode 132 may be disposed on portions of the first, second, fifth, and sixth surfaces 1, 2, 5, and 6 of the body 110, and on the fourth surface 4 of the body 110.

The external electrodes 131 and 132 may be formed of any material as long as they have electrical conductivity, such as metal or the like, and a specific material may be determined in consideration of electrical characteristics, structural stability, or the like, and may further have a multilayer structure.

For example, the external electrodes 131 and 132 may include electrode layers 131a and 132a disposed on the body 110, and plating layers 131b and 132b disposed on the electrode layers 131a and 132a.

As a more specific example of the electrode layers 131a and 132a, the electrode layers 131a and 132a may be sintered electrodes including a conductive metal and glass or resin-based electrodes including a conductive metal and a resin.

In addition, the electrode layers 131a and 132a may have a form in which the sintered electrode and the resin-based electrode are sequentially formed on the body 110.

In addition, the electrode layers 131a and 132a may be formed by transferring a sheet containing the conductive metal onto the body 110, or may be formed by transferring a sheet containing the conductive metal onto the sintered electrode.

As the conductive metal used for the electrode layers 131a and 132a, a material that may be electrically connected to the internal electrode (121 and 122) to form capacitance may be used, but is not particularly limited thereto. For example, the conductive metal may include one or more of nickel (Ni), copper (Cu), palladium (Pd), silver (Ag), gold (Au), platinum (Pt), tin (Sn), tungsten (W), titanium (Ti), and alloys thereof. The electrode layers 131a and 132a may be formed by applying a conductive paste prepared by adding glass frit to a conductive metal powder and then sintering the same.

The plating layer (131b and 132b) may serve to improve mounting characteristics.

A type of the plating layer (131b and 132b) is not particularly limited, may be provided as a single plating layer (131b and 132b) containing at least one of nickel (Ni), tin (Sn), palladium (Pd), or an alloy thereof, and may be formed as a plurality of layers.

For a more specific example of the plating layer (131b and 132b), the plating layer (131b and 132b) may be an Ni plating layer or an Sn plating layer, and the Ni plating layer and the Sn plating layer may be sequentially formed on the electrode layer (131a and 132a). The Sn plating layer, the Ni plating layer, and the Sn plating layer may be sequentially formed. In addition, the plating layer (131b and 132b) may include a plurality of Ni plating layers and/or a plurality of Sn plating layers.

A size of the multilayer electronic component 100 is not particularly limited.

To achieve a small size with high capacitance, thicknesses of the dielectric layer and internal electrode should be thinned to increase the number of stacks. Therefore, an effect according to the present disclosure may become more noticeable in a multilayer electronic component 100 having a size of 1005 (length×width: 1.0 mm×0.5 mm) or less.

Hereinafter, the present disclosure will be described in more detail through examples, but these may be intended to aid specific understanding of the present disclosure and the scope of the present disclosure is not limited by the examples.

### EXAMPLE

Comparative Example 1 was manufactured as a multilayer electronic component in which a side margin portion in which no gallium (Ga) was added was applied.

Inventive Example 1 was manufactured as a multilayer electronic component in which a side margin portion in which 0.3 moles of gallium (Ga) were added relative to 100 moles of titanium (Ti). Inventive Example 1 was manufactured under the same conditions as Comparative Example 1, except that 0.3 moles of gallium (Ga) relative to 100 moles of titanium (Ti) was added to the side margin portion.

Table 1 below illustrates approximate values of sintered densities (g/cm³) measured by taking out sample chips every 25° C. from 1050° C. to 1150° C. during sintering processes of Comparative Example 1 and Inventive Example 1.

TABLE 1

| | Sintered Density (g/cm³) | | | | |
|---|---|---|---|---|---|
| | @1050° C. | @1075° C. | @1100° C. | @1125° C. | @1150° C. |
| Comparative | 4.20 | 4.60 | 5.10 | 5.70 | 5.90 |
| Example 1 | | | | | |
| Inventive | 4.60 | 5.00 | 5.85 | 5.90 | 5.95 |
| Example 1 | | | | | |

In Comparative Example 1, a sintered density at 1050° C. was confirmed to be about 4.20 g/cm³, a sintered density at 1075° C. was confirmed to be about 4.60 g/cm³, a sintered density at 1100° C. was confirmed to be about 5.10 g/cm³, a sintered density at 1125° C. was confirmed to be about 5.70 g/cm³, and a sintered density at 1150° C. was confirmed to be about 5.90 g/cm³. In Inventive Example 1, a sintered density at 1050° C. was confirmed to be about 4.60 g/cm³, a sintered density at 1075° C. was confirmed to be about 5.00 g/cm³, a sintered density at 1100° C. was confirmed to be about 5.85 g/cm³, a sintered density at 1125° C. was confirmed to be about 5.90 g/cm³, and a sintered density at 1150° C. was confirmed to be about 5.95 g/cm³. In Comparative Example 1 in which gallium (Ga) was not added, sintering was almost completed at about 1150° C., whereas in Inventive Example 1 in which gallium (Ga) was added, sintering was almost completed at about 1100° C. Therefore, it can be seen that the sintering temperature was lowered by the addition of gallium (Ga). In addition, referring to results of Inventive Examples 2 to 4, to be described later, it can be predicted that there may be effects of improving dielectric microstructure compaction and moisture resistance reliability, and it can be seen that control of the sintering process becomes easier as the sintering temperature decreases.

Next, atomic percentages (at %) of various elements included in a secondary phase of Inventive Example 2 were measured.

Specifically, Inventive Example 2 was manufactured as a multilayer electronic component in which a side margin portion in which 0.3 moles of gallium (Ga) were added relative to 100 moles of titanium (Ti), and was manufactured under the same conditions as Inventive Example 1.

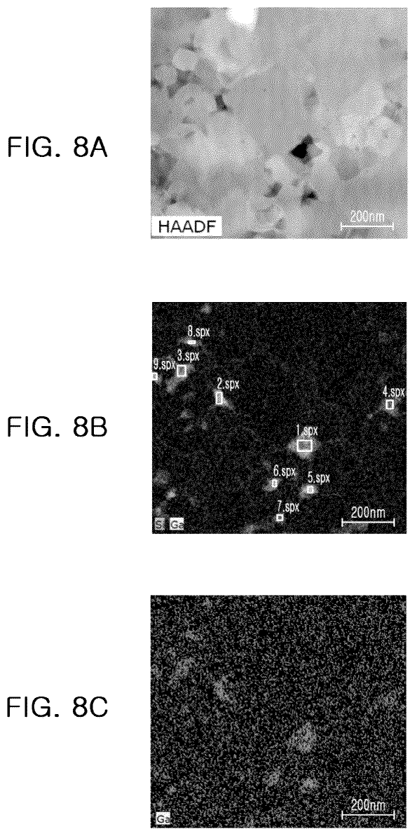

A cross-section of the side margin portion of Inventive Example 2 in the first and third directions was analyzed by TEM-EDS to map and observe gallium (Ga) and silicon (Si), and analysis images thereof can be seen in FIGS. 8A to 8C.

More specifically, FIG. 8A is an image of a side margin portion, captured in a high-angle annular dark-field (HAADF) mode using a transmission electron microscope (TEM), FIG. 8B is an image of silicon (Si) and gallium (Ga) in the same region, analyzed by EDS, and FIG. 8C is an image of gallium (Ga) in the same region, analyzed by EDS.

In addition, as illustrated in FIG. 8B, it can be seen that a secondary phase including gallium (Ga) and silicon (Si) was disposed at a triple point included in the side margin portion, and EDS analysis was performed for 1.spx to 9.spx, which were regions (points) indicated on nine secondary phases, and results therefrom were illustrated in Table 2 below.

Table 2 illustrates atomic percentages (at %) of titanium (Ti), tin (Sn), gallium (Ga), and silicon (Si), measured by TEM-EDS, for each secondary phase region (point) detected in the image, and a ratio of an atomic percentage (at %) of gallium (Ga) relative to an atomic percentage (at %) of silicon (Si) included in the secondary phase was expressed as a percentage (%).

The secondary phase was analyzed to contain at least one of magnesium (Mg), aluminum (Al), vanadium (V), manganese (Mn), zirconium (Zr), barium (Ba), or dysprosium (Dy), but specific atomic percentage (at %) values of the elements were not listed in Table 2.

TABLE 2

| | 1.spx | 2.spx | 3.spx | 4.spx | 5.spx | 6.spx | 7.spx | 8.spx | 9.spx |
|---|---|---|---|---|---|---|---|---|---|
| Ti(at %) | 18.5 | 17.5 | 19.0 | 20.6 | 9.5 | 16.4 | 22.6 | 19.2 | 17.9 |
| Sn(at %) | 0.2 | 0.1 | 0.2 | 0.2 | 0.0 | 0.1 | 0.1 | 0.1 | 0.0 |
| Ga(at %) | 0.4 | 0.5 | 0.3 | 0.3 | 0.7 | 0.4 | 0.2 | 0.3 | 0.3 |
| Si(at %) | 6.2 | 8.8 | 6.7 | 4.6 | 13.4 | 8.1 | 3.6 | 7.2 | 8.4 |
| Ga(at %)/ | 7.21% | 5.84% | 5.05% | 6.95% | 5.19% | 4.81% | 5.93% | 4.83% | 3.94% |
| Si(at %) | | | | | | | | | |

In Inventive Example 2, manufactured under the same conditions as Inventive Example 1, a ratio (Ga/Si) of an atomic percentage (at %) of gallium (Ga) relative to an atomic percentage (at %) of silicon (Si) included in the secondary phase can be confirmed to be 3.94% or more and 7.21% or less. Referring to Inventive Examples 1, 3, and 4, it can be predicted that elements included in the secondary phase suppress occurrence of pores having dielectric microstructure within the atomic percentage (at %) range in Table 2, and improve moisture resistance reliability.

Next, the numbers of pores in a side margin portion for Comparative Example 2 and Inventive Example 3 were compared.

Comparative Example 2 was manufactured as a multilayer electronic component in which a side margin portion in which no gallium (Ga) was added was applied, and was manufactured under the same conditions as Comparative Example 1.

Inventive Example 3 was manufactured as a multilayer electronic component in which a side margin portion in which 0.3 moles of gallium (Ga) were added relative to 100 moles of titanium (Ti), and was manufactured under the same conditions as Inventive Examples 1 and 2.

FIGS. 9A and 9B are images of a region including an end of an internal electrode and one side margin portion, based on a cross-section in the first and third directions at a second direction center of the multilayer electronic component 100, captured by a microscope (SEM).

More specifically, FIG. 9A is an image of a capacitance forming portion and a side margin portion in Comparative Example 2, captured by a scanning electron microscope (SEM), and FIG. 9B is an image of a capacitance forming portion and a side margin portion in Inventive Example 3, captured by a scanning electron microscope (SEM).

In Comparative Example 2 and Inventive Example 3, the number of pores included in a unit area of 150 μm², which corresponds to a tetragonal region of the side margin portion, was observed. In Comparative Example 2, the number of pores was observed to be 45, and in Inventive Example 3, the number of pores was observed to be 21.

From this, it can be confirmed that in Inventive Example 3 in which gallium (Ga) was added, occurrence of pores was suppressed, as compared to Comparative Example 2 in which gallium (Ga) was not added.

Next, moisture resistance reliability evaluations for Comparative Example 3 and Inventive Example 4 were compared.

Comparative Example as a 3 was manufactured multilayer electronic component in which a side margin portion in which no gallium (Ga) was added was applied, and was manufactured under the same conditions as Comparative Example 1 or Comparative Example 2.

Inventive Example 4 was manufactured as a multilayer electronic component in which a side margin portion in which 0.3 moles of gallium (Ga) were added relative to 100 moles of titanium (Ti), and was manufactured under the same conditions as Inventive Examples 1 to 3.

Forty sample chips respectively having the conditions of Comparative Example 3 and Inventive Example 4 were manufactured, and a moisture resistance reliability evaluation thereof was performed.

The moisture resistance reliability evaluation was conducted for 8 hours at a temperature of 85° C., a relative humidity of 85%, and a voltage of 1.2 Vr. Among the 40 sample chips, sample chips of which insulation resistance (IR) value decreased to have 1042 or less were counted as defective, and were listed in Table 3.

TABLE 3

| | Moisture Resistance Reliability Evaluation |
|---|---|
| Comparative Example 3 | 2/40 |
| Inventive Example 4 | 0/40 |

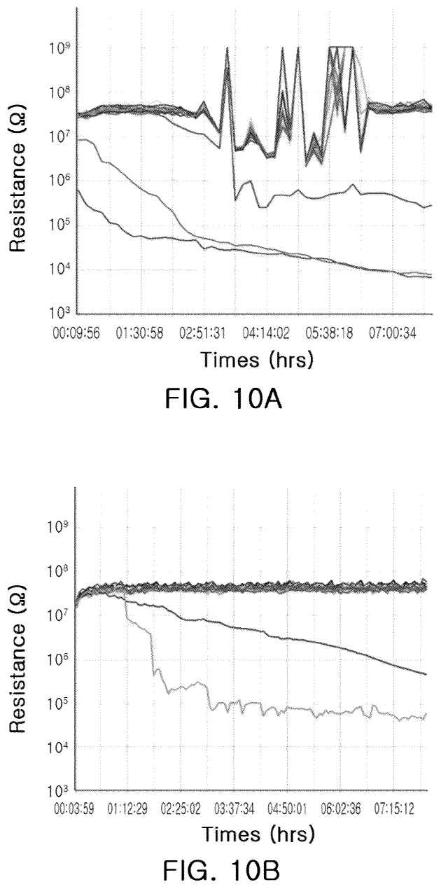

FIG. 10A is a moisture resistance reliability evaluation graph of Comparative Example 3, and FIG. 10B is a moisture resistance reliability evaluation graph of Inventive Example 4. In Comparative Example 3, the number of defective chips can be confirmed to be 2, while in Inventive Example 4, the number of defective chips can be confirmed to be 0. From this, it can be seen that in Inventive Example 4 in which gallium (Ga) was added, moisture resistance reliability was improved, as compared to Comparative Example 3 in which gallium (Ga) was not added.

Next, Comparative Examples and Inventive Examples were manufactured by varying the number of moles of gallium (Ga) relative to 100 moles of titanium (Ti) included in the side margin portion, thirty chips having size 0603 (length×width: 0.6 mm×0.3 mm) were manufactured, dielectric loss factor (dissipation factor, DF), capacitance (F), dielectric breakdown voltage (BDV), and short circuit rate (%) were measured and evaluated, and were listed in Table 4.

TABLE 4

| | Ga | DF | Capacitance | BDV | Short |
|---|---|---|---|---|---|
| | (mol ) | (%) | (μF) | (V) | (%) |
| Comparative Example 4 | 0.0 | 1.60 | 2.111 | 46.25 | 20.0 |
| Comparative Example 5 | 0.0 | 1.51 | 2.115 | 45.35 | 3.3 |
| Inventive Example 5 | 0.9 | 1.54 | 2.110 | 41.20 | 0.0 |
| Inventive Example 6 | 0.9 | 1.51 | 2.159 | 42.50 | 10.0 |
| Inventive Example 7 | 1.5 | 1.65 | 2.177 | 49.25 | 16.7 |
| Inventive Example 8 | 1.5 | 1.64 | 2.197 | 45.10 | 0.0 |
| Inventive Example 9 | 2.0 | 1.68 | 2.201 | 40.15 | 6.7 |
| Inventive Example 10 | 2.0 | 1.66 | 2.187 | 42.75 | 3.3 |
| Inventive Example 11 | 2.5 | 1.72 | 2.199 | 33.55 | 0.0 |
| Inventive Example 12 | 2.5 | 2.16 | 2.209 | 34.90 | 6.7 |
| Inventive Example 13 | 3.0 | 1.66 | 2.123 | 38.45 | 0.0 |

In terms of DF (%), capacitance (MF), BDV (V), and short (%), when comparing Comparative Examples 4 and 5 and Inventive Examples 5 to 13, it can be seen that one or more characteristics among DF, capacitance, BDV, and short may be improved with addition of gallium (Ga). This was expected to be due to an increase in dielectric grain size in a region adjacent to the side margin portion, among the side margin portion and the capacitance forming portion, as gallium (Ga) was added. As an amount of gallium (Ga) increases, BDV characteristics appear to deteriorate. To achieve target characteristics, it is expected that the number of moles of gallium (Ga) relative to 100 moles of titanium (Ti) included in the side margin portion is an appropriate amount up to 3.0 moles.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

According to one of many effects of the present disclosure, a multilayer electronic component having excellent compaction even when sintered at a low temperature may be provided.

According to one of many effects of the present disclosure, a multilayer electronic component having a small number of pores and improved moisture resistance reliability may be provided.

According to one of many effects of the present disclosure, a multilayer electronic component having improved electrical characteristics by reducing a size of a dielectric grain to alleviate an electrical field concentration phenomenon may be provided.

However, various advantages and effects of the present disclosure are not limited to the above-described contents, and can be more easily understood in a process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a capacitance forming portion including a dielectric layer and an internal electrode alternately disposed in a first direction, and cover portions disposed on both end surfaces of the capacitance forming portion in the first direction, respectively, and including a first surface and a second surface opposing each other in the first direction, a third surface and a fourth surface, connected to the first and second surfaces and opposing each other in a second direction, and a fifth surface and a sixth surface, connected to the first to fourth surfaces and opposing each other in a third direction;
external electrodes disposed on the third and fourth surfaces of the body, respectively; and
side margin portions disposed on the fifth and sixth surfaces of the body, respectively,
wherein at least one of the capacitance forming portion, the cover portions, or the side margin portions includes a secondary phase including gallium (Ga).

2. The multilayer electronic component of claim 1, wherein the secondary phase further includes silicon (Si).

3. The multilayer electronic component of claim 1, wherein at least one of the dielectric layer, the capacitance forming portion, the cover portions, or the side margin portions includes a plurality of grains and a grain boundary disposed between adjacent grains, and the secondary phase is disposed at least one triple point at which three or more grain boundaries meet.

4. The multilayer electronic component of claim 3, wherein at least one grain among the plurality of grains includes gallium (Ga).

5. The multilayer electronic component of claim 1, wherein at least one of the dielectric layer, the capacitance forming portion, the cover portions, or the side margin portions includes a plurality of grains and a grain boundary disposed between adjacent grains and including gallium (Ga).

6. The multilayer electronic component of claim 1, wherein an atomic percentage of gallium (Ga) included in the secondary phase is 0.2 at % or more.

7. The multilayer electronic component of claim 2, wherein a ratio of an atomic percentage of gallium (Ga) relative to an atomic percentage of silicon (Si) included in the secondary phase, is 3.94% or more.

8. The multilayer electronic component of claim 1, wherein the number of moles of gallium (Ga) relative to 100 moles of titanium (Ti) included in one of the side margin portions is 0.1 moles or more.

9. The multilayer electronic component of claim 8, wherein the number of moles of gallium (Ga) relative to 100 moles of titanium (Ti) included in the one of the side margin portions is 3.0 moles or less.

10. The multilayer electronic component of claim 1, wherein the secondary phase further includes tin (Sn).

11. The multilayer electronic component of claim 10, wherein an atomic percentage (at %) of tin (Sn) included in the secondary phase is 0.3 at % or less.

12. The multilayer electronic component of claim 1, wherein the side margin portions further include tin (Sn).

13. The multilayer electronic component of claim 12, wherein the number of moles of tin (Sn) relative to 100 moles of titanium (Ti) included in one of the side margin portions is 0.1 moles or more and 5.0 moles or less.

14. The multilayer electronic component of claim 1, wherein 0<MG and 0≤ AG≤ MG are satisfied, in which MG is the number of moles of gallium (Ga) relative to 100 moles of titanium (Ti) included in one of the side margin portions and AG is the number of moles of gallium (Ga) relative to 100 moles of titanium (Ti) included in the capacitance forming portion.

15. The multilayer electronic component of claim 1, wherein 0<MG and 0≤ DG≤ MG are satisfied, in which MG is the number of moles of gallium (Ga) relative to 100 moles of titanium (Ti) included in one of the side margin portions and DG is the number of moles of gallium (Ga) relative to 100 moles of titanium (Ti) included in the dielectric layer.

16. The multilayer electronic component of claim 1, wherein 0<MG and 0≤ CG≤ MG are satisfied in which MG is the number of moles of gallium (Ga) relative to 100 moles of titanium (Ti) included in one of the side margin portions and CG is the number of moles of gallium (Ga) relative to 100 moles of titanium (Ti) included in one of the cover portions.

17. The multilayer electronic component of claim 1, wherein, based on cross-sections of the side margin portions in the first and second directions, the side margin portions are in contact with the external electrode, and a region falling within 10 μm in a direction facing the side margin portions from an interface on which the side margin portions and the external electrode are in contact includes gallium (Ga).

18. The multilayer electronic component of claim 1, wherein the side margin portions include a first side margin portion disposed on the fifth surface of the body, and a second side margin portion disposed on the sixth surface of the body,
wherein at least one of the first and second side margin portions has an average size in the third direction of 20 μm or less.

19. The multilayer electronic component of claim 1, wherein the number of pores per unit area of 150 μm² of one of the side margin portions is 30 or less.

20. The multilayer electronic component of claim 1, wherein the secondary phase further includes at least one of lithium (Li), sodium (Na), potassium (K), rubidium (Rb), or cesium (Cs).

21. The multilayer electronic component of claim 1, wherein the secondary phase further includes at least one of magnesium (Mg), aluminum (Al), vanadium (V), manganese (Mn), zirconium (Zr), barium (Ba), or a rare earth element.

22. A multilayer electronic component comprising:
a body including a capacitance forming portion including a dielectric layer and an internal electrode alternately disposed in a first direction, and including a first surface and a second surface opposing each other in the first direction, a third surface and a fourth surface, connected to the first and second surfaces and opposing each other in a second direction, and a fifth surface and a sixth surface, connected to the first to fourth surfaces and opposing each other in a third direction;
external electrodes disposed on the third and fourth surfaces of the body, respectively; and
side margin portions disposed on the fifth and sixth surfaces of the body, respectively,
wherein 0<MG and 0≤AG≤MG are satisfied, in which MG is the number of moles of gallium (Ga) relative to 100 moles of titanium (Ti) included in one of the side margin portions and AG is the number of moles of gallium (Ga) relative to 100 moles of titanium (Ti) included in the capacitance forming portion.

23. The multilayer electronic component of claim 22, further comprising cover portions disposed on both end surfaces of the capacitance forming portion in the first direction, respectively.

24. The multilayer electronic component of claim 22, wherein at least one of the capacitance forming portion and the side margin portions includes a secondary phase including gallium (Ga).

25. The multilayer electronic component of claim 24, wherein the secondary phase further includes silicon (Si).

26. The multilayer electronic component of claim 24, wherein at least one of the capacitance forming portion and the side margin portions includes a plurality of grains and a grain boundary disposed between adjacent grains, and the secondary phase is disposed at least one triple point at which three or more grain boundaries meet.

27. The multilayer electronic component of claim 26, wherein at least one grain among the plurality of grains includes gallium (Ga).

28. The multilayer electronic component of claim 24, wherein at least one of the capacitance forming portion and the side margin portions includes a plurality of grains and a grain boundary disposed between adjacent grains and including gallium (Ga).

29. The multilayer electronic component of claim 24, wherein an atomic percentage of gallium (Ga) included in the secondary phase is 0.2 at % or more.

30. The multilayer electronic component of claim 25, wherein a ratio of an atomic percentage of gallium (Ga) relative to an atomic percentage of silicon (Si) included in the secondary phase, is 3.94% or more.

31. The multilayer electronic component of claim 22, wherein the number of moles of gallium (Ga) relative to 100 moles of titanium (Ti) included in the one of the side margin portions is 0.1 moles or more.

32. The multilayer electronic component of claim 31, wherein the number of moles of gallium (Ga) relative to 100 moles of titanium (Ti) included in the one of the side margin portions is 3.0 moles or less.

33. The multilayer electronic component of claim 24, wherein the secondary phase further includes tin (Sn).

34. The multilayer electronic component of claim 33, wherein an atomic percentage of tin (Sn) included in the secondary phase is 0.3 at % or less.

35. The multilayer electronic component of claim 22, wherein the side margin portions further include tin (Sn).

36. The multilayer electronic component of claim 35, wherein the number of moles of tin (Sn) relative to 100 moles of titanium (Ti) included in the one of the side margin portions is 0.1 moles or more and 5.0 moles or less.

37. The multilayer electronic component of claim 22, wherein 0<MG and 0≤DG≤MG are satisfied, in which DG is the number of moles of gallium (Ga) relative to 100 moles of titanium (Ti) included in the dielectric layer.

38. The multilayer electronic component of claim 23, wherein 0<MG and 0≤CG≤MG are satisfied, in which CG is the number of moles of gallium (Ga) relative to 100 moles of titanium (Ti) included in one of the cover portions is CG,.

39. The multilayer electronic component of claim 22, wherein, based on cross-sections of the side margin portions in the first and second directions, the side margin portions are in contact with the external electrodes, and a region falling within 10 μm in a direction facing the side margin portions from an interface on which the side margin portions and the external electrodes are in contact includes gallium (Ga).

40. The multilayer electronic component of claim 22, wherein the side margin portions include a first side margin portion disposed on the fifth surface of the body, and a second side margin portion disposed on the sixth surface of the body,
wherein at least one of the first and second side margin portions has an average size in the third direction of 20 μm or less.

41. The multilayer electronic component of claim 22, wherein the number of pores per unit area of 150 μm² of the one of the side margin portions is 30 or less.

42. The multilayer electronic component of claim 24, wherein the secondary phase further includes at least one of lithium (Li), sodium (Na), potassium (K), rubidium (Rb), or cesium (Cs).

43. The multilayer electronic component of claim 24, wherein the secondary phase further includes at least one of magnesium (Mg), aluminum (Al), vanadium (V), manganese (Mn), zirconium (Zr), barium (Ba), or a rare earth element.
